(19) United States
(12) Patent Application Publication
(10) Pub. No.: US 2014/0233926 A1
(43) Pub. Date: Aug. 21, 2014

(54) ELECTRIC FLUID HEATER AND METHOD OF ELECTRICALLY HEATING FLUID

(71) Applicants: Robert Cornelis Van Aken, Prahran (AU); Cedric Israelsohn, Ormond (AU)

(72) Inventors: Robert Cornelis Van Aken, Prahran (AU); Cedric Israelsohn, Ormond (AU)

(73) Assignee: MircoHeat Technologies Pty Ltd, Port Melbourne, Victoria (AU)

(21) Appl. No.: 13/978,573

(22) PCT Filed: Jul. 6, 2011
(86) PCT No.: PCT/AU11/00860

§ 371 Date: Apr. 23, 2014

(30) Foreign Application Priority Data
Jan. 7, 2011 (AU) PCT/AU2011/000016

(51) Int. Cl. F24H 9/20; H05B 3/00; F24H 1/10

(52) U.S. Cl. CPC F24H 9/2028; F24H 1/106; H05B 3/0009
USPC 392/318; 392/338

(57) ABSTRACT

An electric fluid heater includes a body having a fluid inlet and a fluid outlet and defines a fluid passage between the fluid inlet and the fluid outlet. At least two heating assemblies are disposed in the body and arranged in parallel, each heating assembly including at least two electrodes configured to heat fluid by passing alternating electric current through the fluid; wherein the at least two heating assemblies are arranged in the body so that fluid flowing through the fluid passage flows simultaneously through the at least two heating assemblies. Corresponding heating methods and heating systems employing such heaters and methods are also disclosed.

### CROSS-REFERENCE TO RELATED APPLICATIONS

The present application claims priority from International Patent Application No. PCT/AU2011/000016, filed on 7 Jan. 2011, the entire content of which is incorporated herein by reference.

### TECHNICAL FIELD

Embodiments generally relate to electric fluid heaters, methods for heating fluid and systems employing such heaters and heating methods.

### BACKGROUND

Rapid heating of fluid substances is desirable in a range of fields, including automotive, marine, aeronautical and aerospace. For instance, battery performance in cold climates is an ongoing concern for hybrid electric vehicles. It is therefore necessary to warm up the batteries in hybrid electric vehicles in order to achieve acceptable power and energy performance from the batteries. In an especially cold environment, both the battery and the hybrid electric vehicle's engine are cold. To avoid sluggish engine performance, it is desirable to preheat the engine block. In other situations it is the air in a compartment of the vehicle which requires heating for the comfort of passengers.

A heater core or heat exchange system is typically used in heating fluids or gasses. As an example, heated engine coolant, heated by a vehicle's engine, is passed through a heat exchanger of a heater core installed in the vehicle. Air is forced past the heat exchanger by a fan and receives heat from the heat exchanger that is derived from the heated engine coolant. The heated air is then directed into the passenger compartment for the comfort of occupants, or may be directed to the windscreen for demisting or de-icing.

In some applications where heated fluid is needed, space can be quite restricted, for example in coffee machines and other heated fluid dispensers. Conventional heaters can be too bulky or, if they are small, can be too inefficient.

It is desired to address or ameliorate one or more shortcomings or disadvantages associated with prior heating techniques, or to at least provide a useful alternative to such techniques.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to an electric fluid heater comprising:
a body having a fluid inlet and a fluid outlet and defining a fluid passage between the fluid inlet and the fluid outlet; and
at least two heating assemblies disposed in the body and arranged in parallel, each heating assembly comprising at least two electrodes configured to heat fluid by passing alternating electric current through the fluid;
wherein the at least two heating assemblies are arranged in the body so that fluid flowing through the fluid passage flows simultaneously through the at least two heating assemblies.

The electric fluid heater may comprise at least three heating assemblies. At least one of the heating assemblies comprises at least one segmented electrode, each segmented electrode comprising a plurality of electrically separable electrode segments. Each segmented electrode may be controllable by selectively activating one or more of the electrode segments such that upon application of a voltage to the segmented electrode, current drawn by the segmented electrode depends on an effective active area of the selected one or more electrode segments.

The heater may further comprise a controller operable to optimise power applied to heat the fluid by selectively activating or deactivating electrode segments of the one or more segmented electrodes. The controller may be further operable to repeatedly measure the fluid temperature at outputs of each of the heating assemblies and compare the measured temperature outputs with calculated output temperature values.

The at least two heating assemblies may be arranged so that fluid passing from the fluid inlet to the fluid outlet must pass through at least one of the at least two heating assemblies.

The body may have a volume less than about 0.1 m³ and optionally about 0.05 m³, for example. The at least two heating assemblies may be arranged equally spaced about a central axis of the body. The body may be substantially cylindrical or substantially rectangular, at least in part. The at least two electrodes of each heating assembly may be substantially concentric. The surface area of the concentrically arranged electrodes in each heating assembly is such that the correct amount of energy is passed to the water. The surface areas of the electrodes in each of the concentric parallel heating assemblies may be different.

The at least two electrodes of each heating assembly may be formed of an inert electrically conductive material. The inert electrically conductive material may comprise one of a electrically conductive plastic material, a carbon-impregnated material and a carbon-coated material, but are not limited to these materials.

Some embodiments relate to a heat generator to heat a substance, the heat generator comprising:
the electric fluid heater described herein; and
a fluid receptacle to receive heated fluid from the electric fluid heater and to transfer heat from the heated fluid to a substance, wherein the substance to be heated is in proximity to the receptacle that contains the heated fluid.

The fluid heated by the heater may be one of water, ethylene glycol, propylene glycol, a mineral or synthetic oil and a nanofluid. The heater and the fluid receptacle may form part of a closed loop fluid path within which the fluid travels. The heat generator may further comprise a pump to cause fluid to travel through the heater and into the fluid receptacle.

Some embodiments relate to a heating method comprising:
passing fluid through a body having a fluid inlet and a fluid outlet and defining a fluid passage between the fluid inlet and the fluid outlet; and
heating the fluid using at least two heating assemblies disposed in the body and arranged in parallel, each heating assembly comprising at least two electrodes configured to heat fluid by passing alternating electric current through the fluid;
wherein the at least two heating assemblies are arranged in the body so that fluid flowing through the fluid passage flows simultaneously through the at least two heating assemblies.

The method may further comprise pumping heated fluid from the body into a fluid receptacle, wherein the fluid receptacle transfers heat from the heated fluid to a substance which is in proximity to the fluid receptacle. The fluid receptacle may be within a heat exchanger and the method further comprises passing the substance through the heat exchanger. The fluid receptacle, heat exchanger and the body together may form part of a closed fluid loop and the method further comprises circulating the fluid through the closed loop.

The method may further comprise controlling the temperature of the heated fluid in order to control the temperature of the heated substance.

The at least two heating assemblies may comprise at least first, second and third parallel heating assemblies positioned in the fluid passage. The at least two heating assemblies may be arranged so that fluid passing from the fluid inlet to the fluid outlet must pass through at least one of the at least two heating assemblies.

The method may further comprise: measuring fluid conductivity, set flow rate and fluid temperature at the fluid inlet; and from the measured fluid conductivity, flow rate and temperature, determining a required power to be delivered to the fluid via the electrodes to heat the fluid to a set temperature.

The method may further comprise selectively activating or deactivating segmented electrode elements of the at least two electrodes. This may allow optimisation of power transferred to the fluid.

The at least two electrodes of each heating assembly may comprise a segmented electrode, and the heating may comprise selectively activating one or more electrode segments of the segmented electrode such that upon application of a voltage to the segmented electrode, current drawn by the segmented electrode depends on an effective active area of the selected one or more electrode segments.

Some embodiments relate to a method to generate heat to heat a substance, the method comprising:
pumping fluid to an electric fluid heater;
the electric fluid heater heating the fluid by passing alternating electric current through the fluid, which by virtue of the fluid's electrical resistive properties the fluid will heat up; and
pumping heated fluid from the electric fluid heater into a fluid receptacle wherein the fluid receptacle transfers heat from the heated fluid to a substance, the substance being in proximity to the fluid receptacle that contains the heated fluid.

Some embodiments relate to a heat generator to heat a substance, the heat generator comprising:
an electric fluid heater operable to receive fluid and to heat the fluid by passing alternating electric current through the fluid, which by virtue of the fluid's electrical resistive properties the fluid will heat up; and
a fluid receptacle within a heat exchanger to receive heated fluid from the electric fluid heater and to transfer heat from the heated fluid to a substance via the heat exchanger, wherein the substance to be heated is in proximity to the heat exchanger.

This method of heating a substance uses the heat generated by a fluid that is being electrically energised in a controlled fashion. The heat from the fluid can be passed to the substance requiring heating by any means available. Typically the substance to be heated will be positioned or passed in very close proximity to or in direct contact with the fluid receptacle containing the heated fluid. In this way heat exchange will occur and the substance to be heated will heat up. The temperature of the heated substance is controlled by maintaining accurate control of the temperature of the heated fluid.

The fluid receptacle forms a closed loop with the electric fluid heater. In such an embodiment the method comprises circulating the fluid throughout the closed loop. The fluid will typically be circulated in the fluid receptacle which may be either in very close proximity to, or in direct contact with the substance to be heated.

The electric fluid heater operates on electrical power, which may be alternating current (AC) or direct current (DC) power from an electrical source. If a DC source is used, it must be converted to an alternating current and then supplied to the electrodes.

The heat generator is not limited to the specific type of fluid heated by the electric fluid heater though it should be appreciated that it will be one that is electrically and thermally conductive. The selection of the fluid used in any system will in part depend on the desired temperature to be obtained and the application in which the heated substance is to be used. The thermally conductive fluid may be selected from, but not limited to water, ethylene glycol, propylene glycol, mineral or synthetic oils and nanofluids. These fluids are suited for use in heat exchange applications as described herein. In applications where the heated fluid is to be dispensed rather than used for heat exchange, other fluids may be used.

The heat generator is not limited to the form of the fluid receptacle, the configuration of which will depend on the type of substance to be heated and the particular fluid heating application selected. Described fluid heating embodiments have wide application to a number of fluid heating needs.

The fluid receptacle may form a component of a heat exchanger. In one embodiment the substance to be heated may be air and a heat exchanger in the form of a radiator may be provided. In such an embodiment the radiator may transfer heat from the heated fluid to the air (substance) as it flows through the radiator. In other embodiments the fluid receptacle may form a component of a heat exchanger or the like for deployment of a diverse range of applications including polymer curing, autoclave operation, de-icing of windscreens, heating of batteries, and engine preheating.

The electric fluid heater may heat the electrically resistive fluid by passing the fluid along a flow path from an inlet to an outlet. The flow path may comprise at least first and second heating assemblies positioned in parallel along the flow path such that fluid passing the first heating assembly passes the second heating assembly in parallel, each heating assembly comprising at least one pair of electrodes between which the electrically resistive fluid is passed, which, by virtue of its electrical resistance will draw electric current as it passes through the fluid passage along the flow path.

The flow path may comprise at least first, second and third parallel heating assemblies positioned along the flow path such that fluid passes through all three or more heating assemblies in parallel.

The electric fluid heater may be further operable to measure fluid conductivity, flow rate and fluid temperature at the inlet and outlet. From the measured fluid conductivity, flow rate and temperature the electric fluid heater may determine the required power to be delivered to the fluid by the first, second, third and/or n^{th} parallel heating assemblies to raise the fluid temperature the desired amount.

In certain embodiments, at least one of the heating assemblies of the electric fluid heater may comprise at least one segmented electrode, the segmented electrode comprising a plurality of electrically separable electrode segments allowing an effective active area of the segmented electrode to be controlled by selectively activating the segments such that upon application of a voltage to the segmented electrode current drawn will depend upon the effective active area of the selected one or more segments. Further, electrode segment selection may be carried out in a manner to ensure peak current limits are not exceeded. In such embodiments, the measurement of inlet conductivity permits the controller to determine whether the current to be supplied would exceed the current limits and to prevent operation of the electrodes if such current limits will not safely be met.

In certain embodiments, variations in fluid conductivity are substantially continually accommodated in response to measurements of incoming fluid conductivity. Fluid conductivity may be determined by reference to the current drawn upon application of a voltage across one or more electrodes of one or more heating assemblies.

Further embodiments utilise the measured fluid conductivity to ensure that no violation occurs of a predetermined range of acceptable fluid conductivity within which the heat generator is designed to operate.

Moreover, by providing a plurality of parallel heating assemblies, each heating assembly is able to be operated in a manner that allows for changes in electrical conductivity of the fluid with increasing fluid temperature. For example, water conductivity increases with temperature, on average by around 2% per degree Celsius. Where fluid is to be heated by scores of degrees Celsius, for example from room temperature to 60 degrees Celsius or 90 degrees Celsius, inlet fluid conductivity can be substantially different to outlet fluid conductivity.

Electrically energizing the fluid while passing through the parallel heating assemblies along the flow path allows each heating assembly to operate within a defined temperature range. Thus, each heating assembly may apply the appropriate power that is applicable to the fluid conductivity within that defined temperature range rather than attempting to apply power in respect of a single or averaged conductivity value across the entire temperature range.

One or more of the embodiments may further comprise a downstream fluid temperature sensor to measure fluid temperature at the heater outlet, to permit feedback control of the fluid heating.

In some embodiments, each heating assembly may comprise substantially planar electrodes between which the fluid flow path passes. Alternatively, each heating assembly may comprise substantially coaxial cylindrical or curved members with the heating assembly defining an approximately annular volume or channel for fluid flow. The heating assemblies may together define a plurality of parallel flow paths for the fluid.

In some embodiments, the heat generator may comprise three or more heating assemblies, each assembly having an inlet and an outlet, the assemblies being connected in parallel and the control means initially selecting electrode segments in accordance with the measured incoming fluid conductivity, the control means controlling power to an electrode pair of each assembly in accordance with the required fluid temperature which is determined by measuring the system inlet and outlet temperatures.

The volume of fluid passing between any set of electrodes may be determined by a determination of the dimensions of the passage within which the fluid is exposed to the electrodes taken in conjunction with fluid flow.

The time for which a given volume of fluid will receive electrical power from the electrodes may be determined by reference to the flow rate of fluid through the system. The temperature increase of the fluid is proportional to the amount of electrical power applied to the fluid. The amount of electrical power required to raise the temperature of the fluid a known amount, is proportional to the mass (volume) of the fluid being heated and the fluid flow rate through the flow path. The measurement of electrical current flowing through the fluid can be used as a measure of the electrical conductivity, or the specific conductance of that fluid, and hence allows selection of electrode segments to be activated together with system control and management required to keep the applied electrical power constant or at a desired level. The electrical conductivity, and hence the specific conductance of the fluid being heated will change with rising temperature, thus causing a specific conductance gradient along the path of fluid flow.

The energy required to increase the temperature of a body of fluid may be determined by combining two relationships:

Energy=Specific Heat Capacity×Density×Volume×Temp-Change

The energy per unit of time required to increase the temperature of a body of fluid may be determined by the relationship:

$$Power ( P ) = \frac{\begin{matrix}Specific Heat Capacity ( SHC ) \times \\ Density \times Vol ( V ) \times Temp \text{-} Change ( Dt )\end{matrix}}{Time ( T )}$$

For analysis purposes where water is concerned, the specific heat capacity of water, for example, may be considered as a constant between the temperatures of 0 deg Celsius and 100 deg Celsius. The density of water being equal to 1, may also be considered constant. Therefore, the specific heat or amount of energy required to change the temperature of a unit mass of water, 1 deg Celsius in 1 second is considered as a constant and can be labelled “k”. Volume/Time is the equivalent of flow rate (Fr). Thus, the energy per unit of time required to increase the temperature of a body of fluid may be determined by the relationship:

$$Power ( P ) = \frac{k \times Flow rate ( Fr ) \times Temp \text{-} Change ( Dt )}{Time ( t )}$$

Thus if the required temperature change is known, the flow rate can be determined and the power required can be calculated.

In a non-limiting example where the substance to be heated is the air in a vehicle's cabin, a controller input component on the vehicle instrument panel or a remote control device is operated when a user requires heated air. This operation input may be detected by or passed to the electric fluid heater and cause the initiation of a heating sequence. The temperature of the inlet fluid may be measured and compared with a preset desired temperature for fluid output from the system. From these two values, the required change in fluid temperature from inlet to outlet may be determined by the controller.

The temperature of the inlet fluid to the electrode assemblies may be repeatedly measured over time and, as the value for the measured inlet fluid temperature changes, the calculated value for the required temperature change from inlet to outlet of the electrode assemblies can be adjusted accordingly. Similarly, with changing temperature, mineral content and the like, changes in electrical conductivity and therefore specific conductance of the fluid may occur over time. Accordingly, the current passing through the fluid may change, causing the resulting power applied to the fluid to change, and this may be managed by selectively activating or deactivating elements of the segmented electrode(s). Repeatedly measuring the temperature outputs of the heating sections over time and comparing these with the calculated output temperature values will enable repeated calculations to continually optimise the power applied to the fluid.

In some embodiments, a computing means provided by the microcomputer-controlled management system is used to determine the electrical power that should be applied to the fluid passing between the electrodes, by determining the value of electrical power that will effect the desired temperature change between the heating assembly inlet and outlet, measuring the effect of changes to the specific conductance of the water and thereby selecting appropriate activation of electrode segments and calculating the power that needs to be applied for a given flow rate.

In some embodiments, the electrical current flowing between the electrodes within each heating assembly, and hence through the fluid, is measured. The heating embodiment input and output temperatures are also measured. Measurement of the electrical current and temperature allows the computing means of the microcomputer-controlled management system to determine the power required to be applied to the fluid in each heating assembly to increase the temperature of the fluid by a desired amount.

In some embodiments, the computing means provided by the microcomputer-controlled management system determines the electrical power that should be applied to the fluid passing between the electrodes of each heating assembly, selects which electrode segments should be activated in each segmented electrode, and calculates the power that needs to be applied to effect the desired temperature change.

As part of the initial heating sequence, the applied voltage may be controlled in such a way so as to determine the initial specific conductance of the fluid passing between the electrodes. The application of voltage to the electrodes will cause current to be drawn through the fluid passing there-between, thus enabling determination of the specific conductance of the fluid, being directly proportional to the current drawn there-through. Accordingly, management of the electrical power that should be supplied to the fluid flowing between the electrodes in each heating assembly can be correctly applied, in order to increase the temperature of the fluid flowing between the electrodes in each heating assembly by the required amount. The instantaneous current being drawn by the fluid may be continually monitored for change along the length of the fluid flow path. Any change in instantaneous current drawn at any position along the passage is indicative of a change in electrical conductivity or specific conductance of the fluid. The varying values of specific conductance apparent in the fluid passing between the electrodes in the heating assemblies effectively defines the specific conductivity gradient along the heating path.

Various operational parameters of the heater and heat generator are continuously monitored and calculations continuously performed to determine the electrical power that should be supplied to the fluid in order to raise the temperature of the fluid to a preset desired temperature in a given period.

### BRIEF DESCRIPTION OF THE DRAWINGS

Embodiments are described in further detail below, by way of example and with reference to the accompanying drawings, in which:

FIG. 1 illustrates a heat generator to heat a substance according to some embodiments;

FIG. 2 illustrates a heat generator to heat a substance according to some embodiments; and

FIG. 3 illustrates an electric fluid heater, which can be used with the heat generator shown in FIG. 1 or FIG. 2 and which has a parallel arrangement of three heating assemblies, each assembly having a pair of electrodes, one of each of which are segmented into two electrode segments; and

FIG. 4 illustrates an electric fluid heater, which can be used with the heat generator shown in FIG. 1, FIG. 2 or FIG. 3 and which has a parallel arrangement of three heating assemblies, where the electrodes are arranged concentrically.

### DETAILED DESCRIPTION

Embodiments relate generally to electric fluid heaters and heating methods. Some heater and fluid heating embodiments may be employed with a heat generator or heating system to transfer heat from the heated fluid to another substance, such as another fluid, like air or a liquid, like water. The fluid heater and heating method embodiments employ a parallel arrangement of multiple fluid heating assemblies to efficiently and rapidly heat water within a small volume. This parallel arrangement allows the heating device to be contained within a surprisingly small housing for its heating efficiency and power consumption.

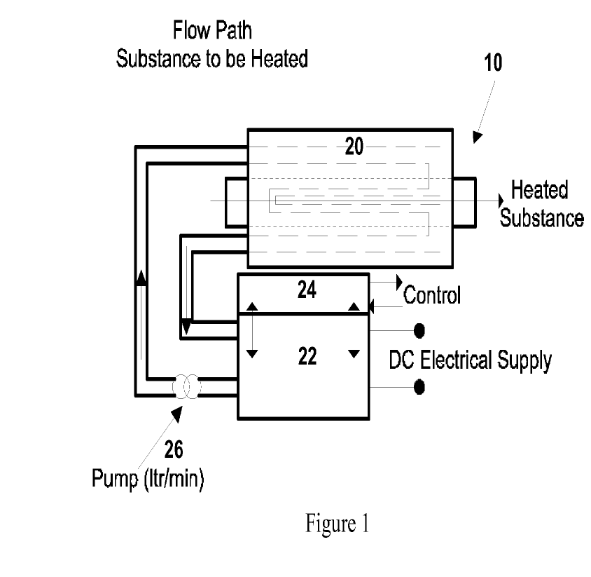

FIG. 1 illustrates some embodiments of a heat generator 10 to heat a target substance, which may be a gas, such as air, or a liquid, such as water or a beverage liquid, for example. The heat generator 10 shows an electric fluid heater 22 controlled by an electronic controller 24 and coupled to a fluid receptacle which forms a component of a conditioning/heat exchanger 20. Various possible configurations of the heat exchanger 20 may be used. The embodiments illustrated in FIG. 1 provide for the electric fluid heater 22 to effectively be thermally coupled to the substance being heated via the heat exchanger 20. The electric fluid heater 22 is used to heat fluid that is circulated between the electric fluid heater 22 and the heat exchanger 20 using a small pump 26. The heat exchanger 20 is used to transfer heat from the heated fluid to the substance being heated. The level of heat transferred is controlled by the electric fluid heater 22 and electronic controller 24.

In this, or similar embodiments, the electric fluid heater 22 uses multiple parallel (and optionally concentric) electrode elements, and heats fluid through the direct application of electrical energy, in the form of alternating current, into the fluid from the electrodes to cause heating within the fluid itself under electronic control. This application of alternating current to the electrodes is intended to substantially avoid the occurrence of electrolysis of the fluid (other than at an instantaneous level for each successive opposite polarity current pulse). The provision if electrical energy to the fluid is thus controlled to minimise chemical interference with the properties of the fluid other than to increase the thermal (kinetic) energy of the fluid.

The electric fluid heater voltage is provided by an electrical power source, such as mains power or a battery. The heater 22 controls fluid flow therethrough to generally achieve a set fluid flow rate and, where applicable, to account for changes in fluid conductivity, for example due to temperature changes. Being a closed loop continuous flow fluid heater, with fluid flow facilitated via a pump 26, the electric fluid heater 22 operates within constrained ranges of variation of temperature and conductivity.

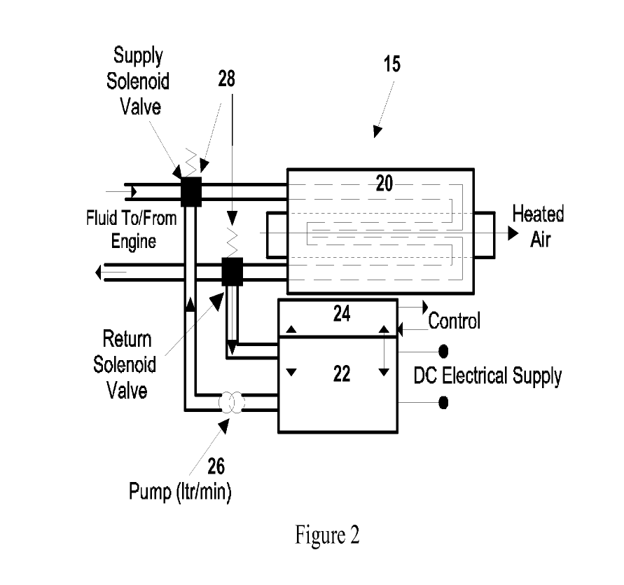

FIG. 2 illustrates further embodiments of a heat generator 15 to heat a target substance, with like numbers illustrating like components as between the embodiments. In this example, the electric fluid heater 22 is used to heat motor vehicle engine coolant. In this context, the term coolant is used to mean a temperature transmission medium, rather than necessarily performing a cooling function. The heated engine coolant is pumped through an existing fluid receptacle within a heat exchanger 20 that is used to heat the air being transferred into the motor vehicle interior. In effect, the heated fluid is circulated in a closed loop between the electric fluid heater 22 and the heat exchanger 20 using a small pump 26. The solenoids 28 in line with the heat exchanger 20 supply/return engine coolant to be heated. The heat exchanger 20 may be used to heat air to be transferred into the vehicle cabin. When the running engine coolant is sufficiently hot enough to allow air to be effectively heated by the heat exchanger 20, the electric fluid heater 22 is isolated using the solenoids 28.

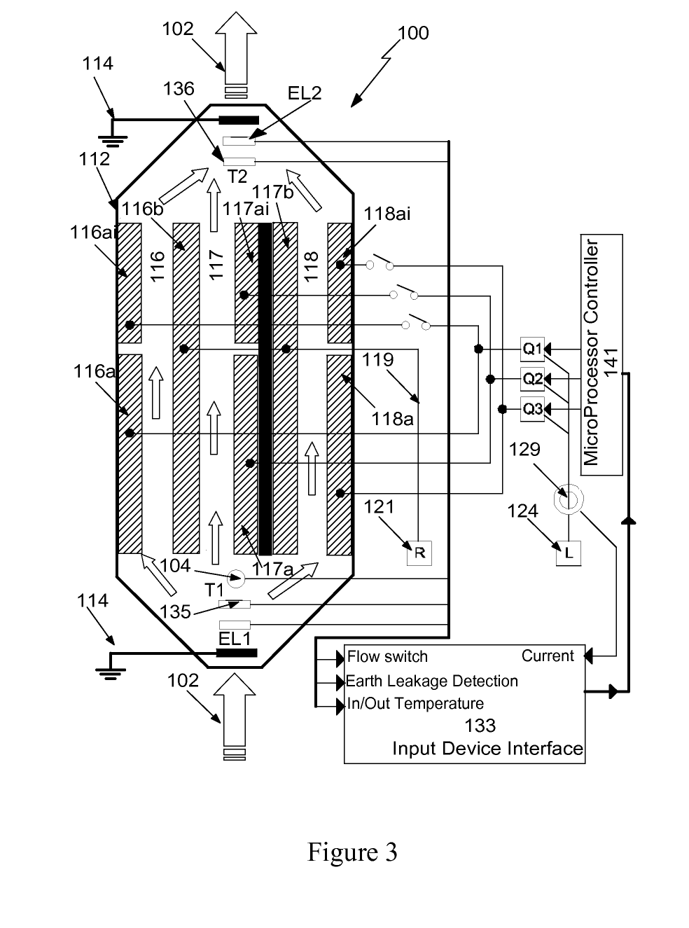

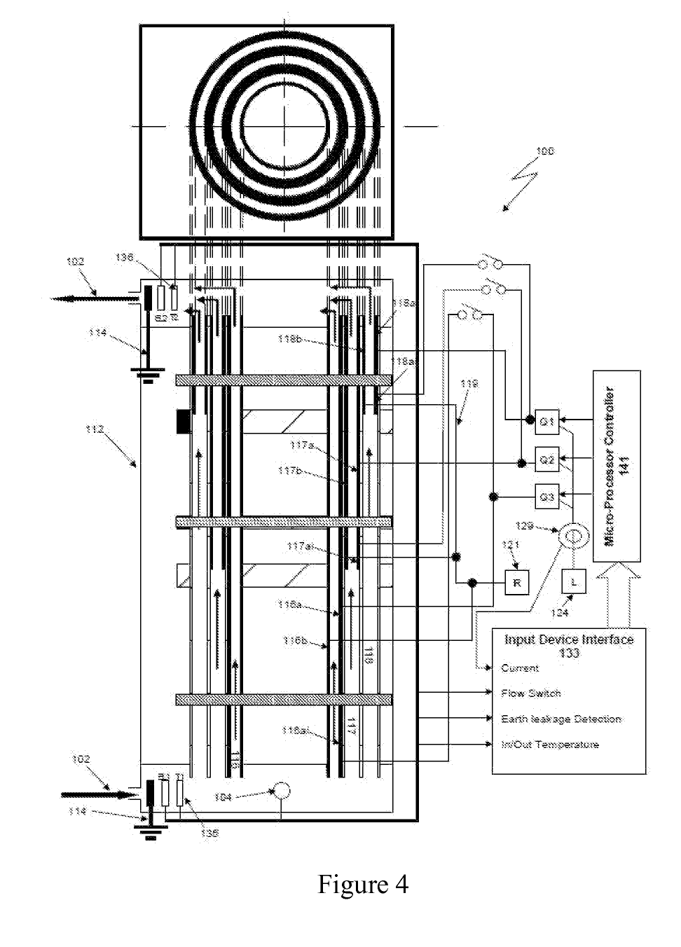

FIG. 3 and FIG. 4 are schematic diagrams of embodiments of an electric fluid heater 100, which may be used as the fluid heater 22 for the heat generator 10 or 15 to heat a substance by heat transfer from a heated fluid. FIG. 3 illustrates embodiments where the electrodes are arranged in a planar configuration, and FIG. 4 illustrates embodiments where the electrodes are arranged in a concentric configuration. The surface areas of the electrodes in each of the concentric parallel heating assemblies may be different or, in some embodiments may be substantially the same. The fluid to be heated, which may include water, ethylene glycol, propylene glycol, a mineral or synthetic oil and a nanofluid, for example, is caused to flow through a body 112 of the electric fluid heater 100.

The body 112 is preferably made from a material that is electrically non-conductive and thermally non- or minimally conductive, such as a synthetic plastic material. However, depending on the application, the body 112 may be connected to metallic fluid pipe, such as aluminium pipe, that is electrically conductive. Accordingly, earth mesh grids 114 shown in FIG. 3 are included at the inlet and outlet of the body 112 so as to electrically earth any metal tubing connected to the apparatus 100. The earth grids 114 would ideally be connected to an electrical earth of the electrical installation in which the heater 100 is installed. As the earth mesh grids 114 may draw current from an electrode through water passing through the apparatus 100, activation of an earth leakage protection within the control system may be effected. The system preferably includes earth leakage circuit protective devices.

In operation, fluid flows into a fluid inlet at one end of the body 112 and out of a fluid outlet at an opposite end, with fluid passing through a fluid passage defined by the body 112, with the direction of flow indicated by flow path arrows 102.

The body 112 may house three heating sections comprising respective parallel heating assemblies 116, 117 and 118, which together defines the fluid flow path of fluid passing from the inlet to the outlet. The heating assemblies 116, 117 and 118 are arranged within the body 112 so that fluid passing from the inlet to the outlet must pass through at least one of the heating assemblies 116, 117 and 118. In some embodiments, two, four, five, six, seven, eight, nine, ten or more such heating assemblies may be employed instead of the three illustrated in FIG. 3. However, for purposes of illustration, embodiments having three heating assemblies are shown and described.

The electrode material of electrodes in the heating assemblies 116, 117 and 118 may be any suitable inert electrically conductive material or a non-metallic conductive material such as a conductive plastics material, carbon impregnated, coated material or the like. It is important that the electrodes are selected of a material to minimise chemical reaction and/or electrolysis. These electrodes are arranged in pairs, with one electrode of the pair being segmented into at least two electrodes segments

The segmented electrode of each electrode pair, being segmented electrodes 116a, 117a and 118a, is connected to a common switched path via separate voltage supply power control devices Q1, Q2, Q3 to the live side 124 of the AC electrical supply, while the other of each electrode pair 116b and 117b is connected to the return side voltage supply 121. The separate voltage supply power control devices Q1, Q2, Q3 switch the live electrical supply 124 in accordance with the power management control provided by microprocessor control system 141. The total electrical current supplied to each individual heating assembly 116, 117 and 118 is measured by a current measuring device 129. The current measurements are supplied as an input signal via input interface 133 to microprocessor control system 141 which acts as a power supply controller for the heating assemblies.

The microprocessor control system 141 has access to a memory (not shown) storing executable program code that, when executed, causes the microprocessor control system 141 (also called a controller herein) to receive data inputs from the measuring devices/sensors, to process that data to make calculations and determinations as described herein and to provide control outputs to the various electrical and fluid control components described herein.

The microprocessor control system 141 also receives signals via input interface 133 from a flow switch device 104 located in the body 112 near the inlet. The volume of fluid passing between any set of electrode segments may be accurately determined by measuring ahead of time the dimensions of the passage within which the fluid is exposed to the electrode segments taken in conjunction with fluid flow. Similarly, the time for which a given volume of fluid will receive electrical power from the electrode segments may be determined by measuring the flow rate of fluid through the passage. The temperature increase of the fluid is proportional to the amount of electrical power applied to the fluid. The amount of electrical power required to raise the temperature of the fluid a known amount is proportional to the mass (or volume for a known fluid density) of the fluid being heated and the fluid flow rate through the passage. The measurement of electrical current flowing through the fluid can be used as a measure of the electrical conductivity or the specific conductance of that fluid and hence allows determination by the microprocessor control system 141 of the change in applied power management required to keep the applied electrical power constant. The electrical conductivity, and hence the specific conductance of the fluid being heated, will change with rising temperature, thus causing a specific conductance gradient along the path of fluid flow.

The microprocessor control system 141 also receives signals via signal input interface 133 from an input temperature measurement device 135 near the inlet to measure the temperature of input fluid to the body 112, an output temperature measurement device 136 measuring the temperature of fluid exiting the body 112.

The fluid heating device 100 is further capable of adapting to variations in fluid conductivity, whether arising from the particular location at which the device is installed or occurring from time to time at a single location. Variations in fluid conductivity will cause changes in the amount of electrical current drawn by each electrode for a given applied voltage. This embodiment monitors such variations and ensures that the device draws a desired level of current by using the measured conductivity value to initially select a commensurate combination of electrode segments before allowing the system to operate.

One electrode of each electrode pair 116, 117 and 118 may be segmented into two electrode segments, 116a and 116ai, 117a and 117ai, 118a and 118ai. For each respective electrode, the ai segment may be fabricated to form about 40% of the active area of the electrode and the a segment may be fabricated to form about 60% of the active area of the electrode, for example. More than two segments may be used and different proportions of active areas may be used for the segments, however. Selection of appropriate electrode segments or appropriate combinations of electrode segments thus allows the appropriate electrode surface area to be selected.

For highly conductive fluid, a smaller electrode area may be selected, so that for a given voltage, the current drawn by the electrode is prevented from rising above desired or safe levels. Conversely, for poorly conductive fluid, a larger electrode area may be selected, so that for the same given voltage, adequate current will be drawn to effect the desired power transfer to the fluid. Selection of segments can be simply effected by switching the power switching devices Q1, . . . , Q3 in or out as appropriate.

The combined surface area of the selected electrode segments is specifically calculated to ensure that the rated maximum electrical current values of the system are not exceeded.

The microprocessor control system 141 receives the various monitored inputs and performs necessary calculations with regard to electrode active area selection and desired electrode pair power to provide a calculated power amount to be supplied to the fluid flowing through the body 112. The microprocessor control system 141 controls the (alternating) pulsed supply of voltage from electric supply connected to each of the heating assemblies 116, 117, 118. Each pulsed voltage supply is separately controlled by the separate control signals from the microprocessor control system 141 to the power switching devices Q1, . . . , Q3.

Based upon the various parameters for which the microprocessor control system 141 receives representative input signals, a computing means under the control of software code executed by the microprocessor control system 141 calculates the control pulses required by the power switching devices in order to supply a required electrical power to impart the required temperature change in the fluid flowing through the body 112 so that heated fluid is emitted from the outlet of the body 112 at or very close to the desired temperature.

The microprocessor control system 141 may have (or have access to in the memory) a stored defined maximum temperature which represents the maximum temperature value above which the fluid may not be heated. The fluid heater 100 may be designed so that, if for any reason, the temperature sensed by the output temperature sensor 136 were greater than the defined maximum temperature, provision of power to the electrodes would be immediately shut off and the fluid pump 26 would be deactivated. Microprocessor control system 141 may remain active in such a situation, however, in order to be able to provide an indication of the nature of the shutdown, for example.

The microprocessor control system 141 repeatedly performs a series of checks to ensure that:

(a) the fluid temperature at the outlet does not exceed the maximum allowable temperature;
(b) leakage of current to earth has not exceeded a predetermined set value; and
(c) system current does not exceed a preset current limit of the system.

These checks are repeatedly performed while the unit is operational and if any of the checks reveals a breach of the controlling limits, at least the electrodes and pump are immediately deactivated. When the initial system check is satisfactorily completed, a calculation is performed to determine the required power that must be applied to the fluid flowing through the body 112 in order to change its temperature by the desired amount. The calculated power is then applied to heating assemblies 116, 117, 118 so as to quickly increase the fluid temperature to the desired temperature as it flows through the body 112 in a single pass.

As the fluid flowing through the body 112 increases in temperature from the inlet end of the body, the conductivity changes in response to increased temperature. The input temperature measuring device 135 and output temperature measuring device 136 measure the temperature differential in the three heating assemblies in the body 112 containing the heating assemblies 116, 117, 118. The power applied to the respective heating assemblies 116, 117, 118 can then be managed to take account of the changes in fluid conductivity to ensure that an even temperature rise occurs along the length of the body 112, to maintain a substantially constant power input to each of the heating assemblies 116, 117, 118 and to ensure greatest efficiency and stability in fluid heating between the input temperature measurement at 135 and the output temperature measurement at 136. The power supplied to the flowing fluid is changed by managing the control pulses supplied by the activated power switching devices Q1 . . . Q3 commensurate with the power required. This serves to increase or decrease the power supplied by individual heating assemblies 116, 117, 118 to the fluid.

The fluid heater 100 repeatedly monitors the fluid for changes in conductivity by referring to the current measuring device 129, and the temperature measurement devices 135 and 136. Any changes in the values for fluid conductivity within the system resulting from changes in fluid temperature increases, changes in fluid constituents as detected along the length of the body 112 or changes in the detected currents drawn by the fluid cause the computing means to calculate revised average power values to be applied to the heating assemblies 116, 117 and 118.

Changes in incoming fluid conductivity cause the microprocessor control system 141 to selectively activate changed combinations of electrode segments 116a and 116ai, 117a and 117ai, 118a and 118ai. Constant closed loop monitoring of such changes to the system current, individual electrode currents and electrode segment fluid temperature allows recalculation of the power to be applied to the individual heating assemblies to enable the system to supply relatively constant and stable power to the fluid flowing through the fluid heater 100. The changes in specific conductance of the fluid passing through the separate segmented heating assemblies can be managed separately in this manner. Therefore the fluid heater 100 is able to effectively control and manage the resulting specific conductance gradient across fluid in the body 112.

Embodiments thus provide compensation for a change in the electrical conductivity of the fluid caused by varying temperatures and varying concentrations of dissolved chemical constituents, and through the heating of the fluid, by altering the power to accommodate for changes in specific conductance when increasing the fluid temperature by the desired amount.

It will be appreciated that any suitable number of electrode heating assemblies may be used in the performance of described embodiments. Thus, while the embodiments described show three heating sections for heating the fluid flowing through body 112, the number of heating assemblies in the passage may be altered in accordance with individual requirements or applications specific for fluid heating. If the number of heating assemblies is increased to, for example, six pairs, each individual heating assembly may be individually controlled with regards to power in the same way as is described in relation to the embodiments herein. Similarly, the number of electrode segments into which a single electrode is segmented may be different to two. For example, segmentation of an electrode into four segments having active areas in a ratio of 1:2:4:8 provides 15 values of effective area which may be selected by the microprocessor control system 141.

It is to be appreciated that by utilising heating assemblies which cause current to flow through the fluid itself such that heat is generated from the resistivity of the fluid itself, the embodiments obviate the need for electrical resistance heating elements, thus ameliorating the problems associated with element scaling or failure. Further the compact arrangement of the parallel heating assemblies allows the fluid heater to be quite space efficient relative to prior heating systems.

Some portions of this detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

Described acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while embodiments are described in the foregoing context, it is not meant to be limiting as those of skill in the art will appreciate that various of the acts and operations described may also be implemented in hardware.

It should be borne in mind, however, that all of these and similar terms are to be associated with the appropriate physical quantities and are merely convenient labels applied to these quantities. Unless specifically stated otherwise as apparent from the description, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Numerous variations and/or modifications may be made to the embodiments without departing from the scope of the invention as broadly described. The present embodiments are, therefore, to be considered in all respects as illustrative and not restrictive.

1. An electric fluid heater, comprising:
a body having a fluid inlet and a fluid outlet and defining a fluid passage between the fluid inlet and the fluid outlet; and
at least two heating assemblies disposed in the body and arranged in parallel, each heating assembly comprising at least two electrodes configured to heat fluid by passing alternating electric current through the fluid;
wherein the at least two heating assemblies are arranged in the body so that fluid flowing through the fluid passage flows simultaneously through the at least two heating assemblies.

2. The heater of claim 1, wherein the at least two heating assemblies comprise at least three heating assemblies.

3. The heater of claim 1, wherein at least one of the heating assemblies comprises at least one segmented electrode, each segmented electrode comprising a plurality of electrically separable electrode segments.

4. The heater of claim 3, wherein each segmented electrode is controllable by selectively activating one or more of the electrode segment such that upon application of a voltage to the segmented electrode, current drawn by the segmented electrode depends on an effective active area of the selected one or more electrode segments.

5. The heater of claim 3, wherein the heater further comprises a controller operable to optimise power applied to heat the fluid by selectively activating or deactivating electrode segments of the one or more segmented electrodes.

6. The heater of claim 5, wherein the controller is further operable to repeatedly measure the fluid temperature at outputs of each of the heating assemblies and compare the measured temperature outputs with calculated output temperature values.

7. The heater of claim 1, wherein the at least two heating assemblies are arranged so that fluid passing from the fluid inlet to the fluid outlet must pass through at least one of the at least two heating assemblies.

8. The heater of claim 1, wherein the body has a volume less than about 0.05 m³.

9. The heater of claim 1, wherein the at least two heating assemblies are arranged equally spaced about a central axis of the body.

10. The heater of claim 1, wherein the body is substantially cylindrical.

11. The heater of claim 1, wherein the at least two electrodes of each heating assembly are substantially concentric.

12. The heater of claim 1, wherein the at least two electrodes of each heating assembly are formed of an inert electrically conductive material.

13. The heater of claim 12, wherein the inert electrically conductive material is one of an electrically conductive plastic material, a carbon-impregnated material and a carbon-coated material.

14. A heat generator to heat a substance, the heat generator comprising:
the electric fluid heater of claim 1; and
a fluid receptacle to receive heated fluid from the electric fluid heater and to transfer heat from the heated fluid to a substance, wherein the substance to be heated is in proximity to the fluid receptacle that contains the heated fluid.

15. The heat generator of claim 14, wherein the fluid heated by the heater is one of water, ethylene glycol, propylene glycol, a mineral or synthetic oil and a nanofluid.

16. The heat generator of claim 14, wherein the heater and the fluid receptacle form part of a closed loop fluid path within which the fluid travels.

17. The heat generator of claim 14, further comprising a pump to cause fluid to travel through the heater and into the fluid receptacle.

18. A heating method, comprising:
passing fluid through a body having a fluid inlet and a fluid outlet and defining a fluid passage between the fluid inlet and the fluid outlet; and
heating the fluid using at least two heating assemblies disposed in the body and arranged in parallel, each heating assembly comprising at least two electrodes configured to heat fluid by passing alternating electric current through the fluid;
wherein the at least two heating assemblies are arranged in the body so that fluid flowing through the fluid passage flows simultaneously through the at least two heating assemblies.

19. The method of claim 18, further comprising pumping heated fluid from the body into a fluid receptacle, wherein the fluid receptacle transfers heat from the heated fluid to a substance which is in proximity to the fluid receptacle.

20. The method of claim 19, wherein the fluid receptacle is within a heat exchanger and the method further comprises passing the substance through the heat exchanger.

21. The method of claim 20, wherein the fluid receptacle, heat exchanger and the body together form part of a closed fluid loop and the method further comprises circulating the fluid through the closed loop.

22. The method of claim 19, further comprising controlling the temperature of the heated fluid in order to control the temperature of the heated substance.

23. The method of claim 18, wherein the at least two heating assemblies comprise at least first, second and third parallel heating assemblies positioned in the fluid passage.

24. The method of claim 18, further comprising:
measuring fluid conductivity, set flow rate and fluid temperature at the fluid inlet; and
from the measured fluid conductivity, flow rate and temperature, determining a required power to be delivered to the fluid via the electrodes to heat the fluid to a set temperature.

25. The method of claim 18, further comprising selectively activating or deactivating segmented electrode segments of the at least two electrodes.

26. The method of claim 18, wherein the at least two electrodes of each heating assembly comprise a segmented electrode, wherein the heating comprises selectively activating one or more electrode segments of the segmented electrode such that upon application of a voltage to the segmented electrode, current drawn by the segmented electrode depends on an effective active area of the selected one or more electrode segments.

27. The method of claim 18, wherein the at least two heating assemblies are arranged so that fluid passing from the fluid inlet to the fluid outlet must pass through at least one of the at least two heating assemblies.
